(19) United States
(12) Patent Application Publication
(10) Pub. No.: US 2007/0006072 A1
(43) Pub. Date: Jan. 4, 2007

(54) Constraint-optimization method for document layout using tradeoff generation

(75) Inventor: Lisa Purvis, Fairport, NY (US)

Correspondence Address: FAY, SHARPE, FAGAN, MINNICH & MCKEE, LLP, 1100 SUPERIOR AVENUE, SEVENTH FLOOR, CLEVELAND, OH, 44114, US

(73) Assignee: XEROX CORPORATION

(21) Appl. No.: 11/170,610

(22) Filed: Jun. 29, 2005

(51) Int. Cl. G06F 17/24

(52) U.S. Cl. 715/517

(57) ABSTRACT

A method for automated document layout using interactive tradeoff generation during the optimization of a constraint satisfaction problem (CSP) is provided. The method includes generating a constraint satisfaction problem describing the layout of the items in the document as a problem having constraints, finding inconsistent constraints which are incapable of being satisfied together, generating tradeoffs for the inconsistent constraints capable of eliminating one or more of the inconsistent constraints, choosing one or more of the tradeoffs as being one or more acceptable tradeoffs and using them to optimize the CSP to arrive at an optimized document layout.

### BACKGROUND

Illustrated herein are embodiments of a system and method relating to determining a document layout of items in a document using interactive tradeoff generation for constraint-based approaches wherein the document, its content components, and its requirements are expressed as elements of a constraint satisfaction problem. The embodiments disclosed herein find particular application in conjunction with the assembly of document components into a custom document and will be described with particular reference thereto. However, it is to be appreciated that these embodiments are also amenable to other like applications.

Custom documents are documents that are personalized or tailored in some way to the particular user of the document. Two growing applications of custom documents are variable data printing, and web personalization.

In traditional variable data applications the creation of a custom document is accomplished by an expert in graphic arts, databases, layout, document design, etc. This expert document creator, also referred to as a layout designer, develops an overall layout for the document that includes places for the variable data. The creator also finds or creates appropriate content pieces, and specifies rules for how to fill in the variable slots with this content, or places the content in a database and then links the slots to particular fields in the database. The variable data application then creates a document for each customer by inserting the data for the customer into its linked slot. These types of templates are typically called “lick and stick”, because the template has “art holes” which are defined by the document creator, and then the variable data is placed into those art holes to form different instances of the document. The resulting set of documents is typically quite similar: each variable slot has one piece of content of about the same size and the general layout is the same for all instances, regardless of the available content pieces. Thus, the traditional ‘variable data template’ not only requires extensive time and expertise from the document creator, but it also does not respond dynamically to varying amounts or types of content pieces, or to restrictions imposed by the variable content.

In the domain of web documents and web personalization, the focus is often not on a dynamic document layout per se but rather on dynamic data. The assumption is that the document template is pre-determined and the challenge is to find the right data at the right time. For instance, dynamic web documents are typically formed by embedding “scripts” (i.e., programs) into the HTML page. These scripts are then interpreted by the web server. This enables certain elements of the document (e.g., a weather reading) to be inserted or created at the time of document display. This approach can only produce documents according to the underlying program. In order to achieve different results, the program must be changed and thus this approach is not truly dynamic. In web personalization applications, much of the focus is on user profiling and understanding what e-commerce customers are doing online so that you can provide the appropriate information. Again, the focus is on finding the appropriate information, not on laying it out differently based on what is found. The techniques used to create dynamic web pages often involve writing specific scripts or programs that can be embedded in web pages and interpreted by the web server. This approach lacks in generality, introduces restrictive platform dependencies, and can be extremely difficult and expensive to maintain.

Traditional creation of custom documents such as variable data documents requires expertise in many areas such as graphic arts and databases and is a time consuming process. With the ever-increasing amount of information in the digital world and the amount of untrained users producing documents, old publishing tools often prove cumbersome and demanding whereas present dynamic digital environments demand tools that can reproduce both the contents and the layout automatically tailored to personal needs and which can enable novices to easily create such documents.

In the realm of custom document creation, what is needed in the arts is a way to automatically select document content and lay it out into a final document, without relying on expert graphic artists, or using specialized scripts that are embedded in an HTML file.

Known methods for automated creation of documents have focused more on particular types of documents, and not on modeling the problem in a general way in order to address all types of documents. Existing work provides methods for creating diagrams (see Dengler, E. Friedell, M., Marks, J., Constraint-Driven Diagram Layout, Proceedings of the 1993 IEEE Symposium on Visual Languages, pages 330-335, Bergen, Norway, 1993), or multimedia presentations (see Rousseau, F., Garcia-Macias, A., Valdeni de Lima, J., and Duda, A., User Adaptable Multimedia Presentations for the WWW, Electronic Proceedings from the 8^{th} International World Wide Web Conference, 1999), or flowcharts and yellow pages (see Graf, W. H., The Constraint-Based Layout Framework LayLab and Applications, Electronic Proceedings of the ACM Workshop on Effective Abstractions in Multimedia, 1995). Others have explored automating the process of web document layout (see Lorener, A., The Design Composer: Context-Based Automated Layout for the Internet, Proceedings of the AAAI Fall Symposium Series: Using Layout for the Generation, Understanding, or retrieval of Documents, 1999). None of the existing automated approaches provide a formalized, constraint-satisfaction formulation of the document creation process, nor do they include the selection of content in their automated process. Furthermore, existing automated approaches concentrate solely on a single type of document. What is needed in the arts is a way to eliminate some of the traditional limitations of custom document creation by providing a methodology that supports a flexible and efficient assembly of document components resulting in truly dynamic and personalized documents.

However, the document layout problem typically includes constraints specifying relationships between variables and/or values that must hold in order for the resulting document layout to be valid. In such constraint-based problems not all constraints can typically be satisfied at once, requiring tradeoffs to be made. Current approaches typically use a weighting scheme to rank the multiple constraints in terms of their importance to one another. It is often difficult for a user to accurately specify the weightings that will lead to the desired solution since such an approach requires in-depth information concerning various tradeoffs and valuations of each solution. This information is not commonly fully available in practice. Furthermore, in dynamic and personalized systems, the preferences can change over time, from designer to designer, and even from solution to solution.

It is desirable to provide a system and method which assists a document layout designer in choosing tradeoffs for satisfying the constraints involved with achieving an optimal document layout.

### CROSS REFERENCE TO RELATED PATENTS AND APPLICATIONS

Attention is directed to commonly owned and assigned copending Application Numbers:

U.S. Ser. No. 10/202,046, filed Jul. 23, 2002 entitled “CONSTRAINT-OPTIMIZATION SYSTEM AND METHOD FOR DOCUMENT COMPONENT LAYOUT GENERATION” which is incorporated herein by reference in its entirety.

U.S. Ser. No. 10/202,188, filed Jul. 23, 2002 entitled “CONSTRAINT-OPTIMIZATION SYSTEM AND METHOD FOR DOCUMENT COMPONENT LAYOUT GENERATION” which is incorporated herein by reference in its entirety.

U.S. Ser. No. 10/202,183, filed Jul. 23, 2002 entitled “SYSTEM AND METHOD FOR CONSTRAINT-BASED DOCUMENT GENERATION” which is incorporated herein by reference in its entirety.

U.S. Ser. No. 10/202,275, filed Jul. 23, 2002 entitled “SYSTEM AND METHOD FOR CONSTRAINT-BASED DOCUMENT GENERATION” which is incorporated herein by reference in its entirety.

U.S. Ser. No. 10/202,207, filed Jul. 23, 2002 entitled “SYSTEM AND METHOD FOR DYNAMICALLY GENERATING A STYLE SHEET” which is incorporated herein by reference in its entirety.

U.S. Ser. No. 10/202,247, filed Jul. 23, 2002 entitled “SYSTEM AND METHOD FOR DYNAMICALLY GENERATING A STYLE SHEET” which is incorporated herein by reference in its entirety.

U.S. Ser. No. 10/202,047, filed Jul. 23, 2002 entitled “CASE-BASED SYSTEM AND METHOD FOR GENERATING A CUSTOM DOCUMENT” which is incorporated herein by reference in its entirety.

U.S. Ser. No. 10/202,227, filed Jul. 23, 2002 entitled “CASE-BASED SYSTEM AND METHOD FOR GENERATING A CUSTOM DOCUMENT” which is incorporated herein by reference in its entirety.

### BRIEF DESCRIPTION

What is disclosed is a method for specifying a custom document as a constraint satisfaction problem (CSP) to create the specified document using existing constraint solving algorithms wherein the document, its content components, and its layout requirements are posed as elements of a constraint satisfaction problem which when solved, results in an automated document layout for the set of content components.

The method includes generating a constraint satisfaction problem describing the layout of the items in the document as a problem having constraints, finding inconsistent constraints which are incapable of being satisfied together, generating tradeoffs for the inconsistent constraints capable of eliminating one or more of the inconsistent constraints, choosing one or more of the tradeoffs as revised constraints, replacing constraints with revised constraints to optimize the constraint satisfaction problem and arrive at an optimized document layout.

Other objects, advantages, and salient features of the invention will become apparent from the detailed description which, taken in conjunction with the drawings, disclose the preferred embodiments of the invention.

### BRIEF DESCRIPTION OF THE DRAWINGS

The preferred embodiment and other aspects of the invention will become apparent from the following detailed description when taken in conjunction with the accompanying drawings which are provided for the purpose of describing the invention and not for the limitation thereof, in which:

FIG. 1 illustrates a document template specifying perfect Balance in the placement of documents A and B;

FIG. 2 illustrates a document template specifying perfect noOverlap for documents A and B;

FIG. 3 illustrates a document template sacrificing a lower score for noOverlap while achieving better balance for documents A and B;

FIG. 4 illustrates a document template sacrificing a lower score for Balance while achieving better score for noOverlap for documents A and B;

FIG. 5 is a flow chart illustrating a current embodiment;

FIG. 6 illustrates a document template specifying constraints illustrating a trade off of achieving a lower score for horizontal balance while maximizing the score for noOverlap; and

FIG. 7 illustrates a document template specifying constraints which achieve a lower score for noOverlap but achieves a better score for horizontal balance than that shown in FIG. 6.

### DETAILED DESCRIPTION

What is disclosed is a system and method for specifying a custom document as a constraint satisfaction problem (CSP) to create the specified document using existing constraint solving algorithms. A set of content components and layout requirements form elements in a constraint satisfaction problem which when solved results in an automated document layout. For some layout problems, the content components and layout requirements result in some constraints that cannot all be satisfied at once. A system and method for interactive tradeoff generation method is applied to help the user specify preferred solutions during the optimization of the CSP in order to find the preferred solution.

The document is expressed as a template made up of variables, values, and constraints. An instance of that template is then created, resulting in a set of content and a layout of that content, by using a constraint satisfaction algorithm. Examples of known constraint satisfaction problems, or algorithms, can include, but are not limited to, backtracking, and forward checking. The embodiments described herein illustrate a method of document layout which includes posing the layout problem as a constraint satisfaction problem, iterating an optimization algorithm to find one or more inconsistent design constraints, interactively generating one or more acceptable tradeoffs which eliminate the inconsistent design constraints, and optimizing the constraint satisfaction problem using the tradeoffs.

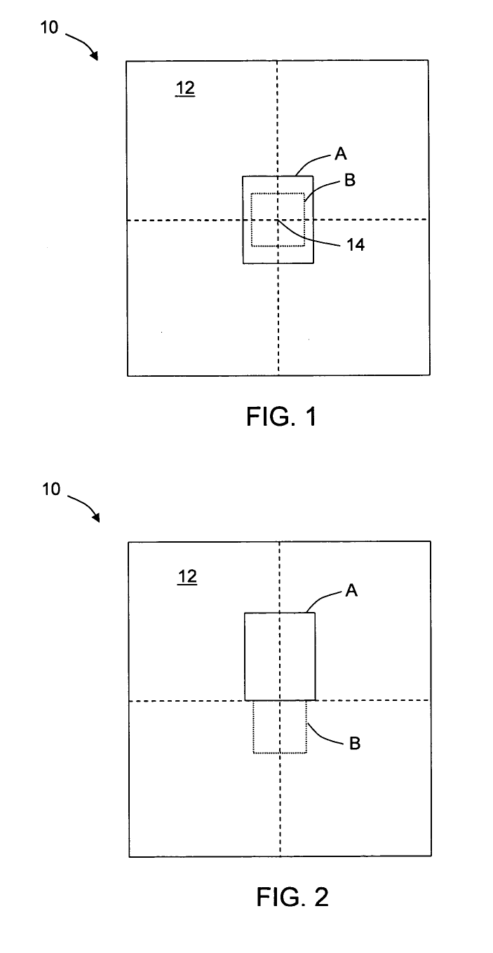

In particular, a document template 10 is represented as a constraint satisfaction problem containing a set of variables, a value domain for each variable, and one or more sets of constraints on those variables and values. In the document layout problem described herein, the areas of the document to be filled with content are modeled as problem variables, as are any parameters of the document that can be changed. As an example, consider the document template shown generally at 10 in FIG. 1. The template 10 corresponds to a portion of a document 12, including but not limited to a portion of a document page, to an entire document page, or to a portion of more than one document page. The template 10 provides an indication of the layout of items of content in the document. In the example provided herein, which should not be considered limiting, the template 10 specifies that there are two items of content which occupy an area 12 in the document, item A occupying an area shown as a solid rectangle, and item B occupying an area shown as a dotted rectangle. As shown in FIG. 1, the items A and B may occupy some of the same portions of the document, that is to say the items of content may overlap.

The template 10 enables the positions of item A and item B to be changed during the document layout process as indicated by problem variables. The constraint satisfaction problem formulation further specifies that each problem variable has a value domain consisting of the possible values to assign to that variable. This invention teaches that for variables that are document areas to be filled with content (e.g. areaA and areaB of FIG. 1), the value domains are the content pieces that are applicable to each area. For variables that are document parameters, the value domains are discretized ranges for those parameters, so that each potential value for the parameter appears in the value domain. The initial value domain is set up to be some default range e.g., [1 . . . MAXINT]. For variables whose value domains are content pieces, the default domain is set up to be all possible content pieces in the associated content database, which is specified in the document template.

The document layout problem includes constraints specifying relationships between variables and/or values that must hold in order for the resulting document layout to be valid. Constraints may be unary (apply to one variable), binary (apply to two variables/values), and/or n-ary (apply to n values/variables).

In the example provided herein, the document layout problem includes laying out items A and B on a document page in an effort to achieve two objectives: balance and no overlap, also referred to as noOverlap, of the items. These objectives can be independently evaluated using a number, or score, to represent how close to the ideal, or maximum, any particular solution to the Constraint Satisfaction Problem gets. In this example, the definition of perfect balance means that each item is placed in the center of the page, shown at 14, and the balance score for an item gets progressively worse as the item gets farther from the center. Achieving perfect balance, that is achieving the highest balance score, results in solutions such as shown in FIG. 1, where both items A and B are situated at the center of the page. However, achieving perfect balance with the two items sacrifices the second objection of no overlap, thereby reducing the no overlap score. Similarly, achieving a high score in no overlap, as shown in FIG. 2, sacrifices balance thereby reducing the balance score. Thus, achieving the best of both objectives, at the same time, will require some tradeoffs to be made.

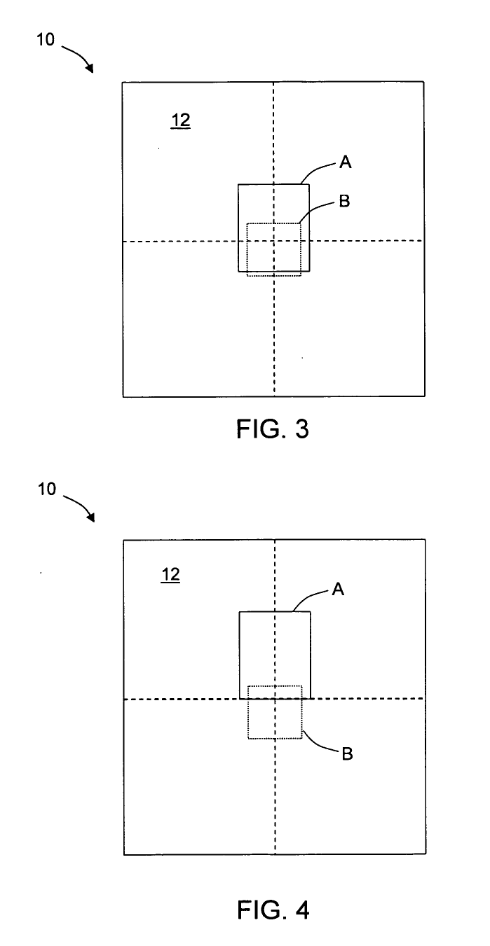

Without weighting the various document layout objectives, many different solutions to the layout problem will appear to be of the same goodness. For example, each of the solutions shown in FIGS. 3 and 4 would be evaluated as having the same score for the combined objective function that looks to maximize balance and minimize overlap of items A and B.

However, a document layout designer typically prefers one solution over the other. If a designer would sacrifice balance in order to achieve a higher score in noOverlap, then the solution shown in FIG. 4 would be preferred. Using this simple example, it seems that a layout designer would easily be able to specify a weighting scheme that weights the noOverlap constraints higher than balance constraints, and this would achieve the desired result. However, in real-world design scenarios, there are many competing constraints to consider, including but not limited to, alignment, balance, noOverlap, stayWithinMargins, legibility, imageAspectRatio, etc. This makes it very difficult if not virtually impossible for a layout designer to accurately specify all of the proper weightings for each set of constraints in order to find solutions to the document layout problem that match the overall design criteria. This is aggravated by the fact that the weightings might change from document to document, or situation to situation. For instance, in a marketing brochure, perhaps overlap is tolerable and could therefore be weighted low in order to enable inserting many more images. However, in a financial brochure, overlap might not be tolerable in order to make all of the text legible, and should therefore be weighted higher.

The system and method for document layout described herein uses one or more known tradeoff generation techniques to interactively involve the layout designer in specifying the tradeoffs during the optimization of the constraint satisfaction problem, thereby alleviating the need to specify each weighting before the optimization process.

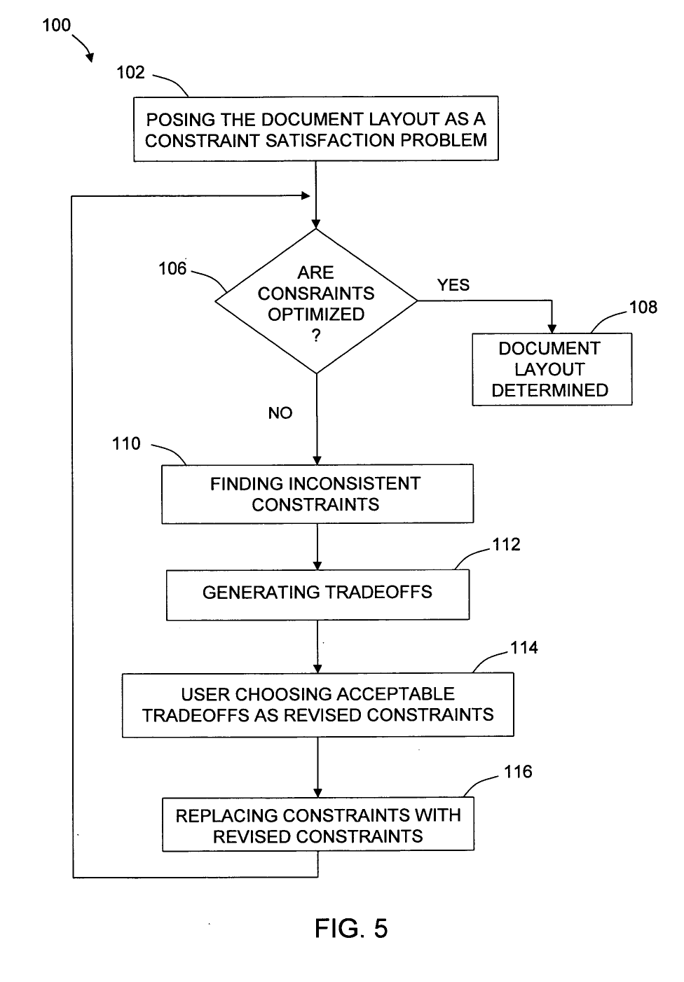

Referring now to FIG. 5, a method of determining a layout of items in a document is shown generally at 100. The method 100 includes generating a constraint satisfaction problem at 102 describing the layout of the items in the document as a constraint satisfaction problem having constraints. Using a Constraint Satisfaction Problem formed from a set of n variables, each with an associated domain, and one or more sets of constraining relations each involving a subset of the variables, an attempt is made to find all possible n-tuples such that each n-tuple is an instantiation of the n variables satisfying the relations.

In the example provided herein, the constraint satisfaction problem includes the design objectives of maximizing the balance of the placement of two items A and B in the document while minimizing their overlap, referred to herein as maximizing noOverlap. More specifically, the constraint satisfaction problem defining the document layout problem includes six constraints (C1-C6), as described below, with (0,0) being the center of the document page to be laid out. However, it should be appreciated that this example is simplified for the purposes of clarity and the constraint satisfaction problem defining the layout problem can include any suitable number of constraints. The constraints in this example include:

HorizontalBalance for A (C1): Aₓₚₒₛ=0−A_{width}/2. Constraint C1 states that A's top-left corner x position must be half of A's width to the left of the page's origin so that the center of A in the x dimension is at the page origin (0,0).

HorizontalBalance for B (C2): Bₓₚₒₛ=0−B_{Width}/2. Constraint C2, for B, is similar to constraint C1 for A.

VerticalBalance for A (C3): A_{ypos}=0−A_{height}/2. Constraint C3, for A, states that A's top-left corner y position must be half of A's height above the page's origin so that the center of A in the y dimension is at the page origin (0,0).

VerticalBalance for B (C4): B_{ypos}=0−B_{height}/2. Constraint C4, for B, is similar to constraint C2 for A.
NoOverlap in x position (C5): Aₓₚₒₛ>=Bₓₚₒₛ+B_{width}
or NoOverlap in x position (C5): Aₓₚₒₛ+A_{width}<=Bₓₚₒₛ
NoOverlap in y position (C6): A_{ypos}>=B_{ypos}+B_{height}
or NoOverlap in y position (C6): A_{ypos}+A_{height}<+B_{ypos}

The method 100 also includes determining if the constraints are optimized at 106. The constraints are optimized when no inconsistent constraints can be found. Inconsistent constraints are constraints which are incapable of being satisfied together. If it is determined in step 106 that the constraints C1-C6 are optimized the document layout is determined at 108.

If it is determined at 106 that the constraints are not optimized, the method 100 includes finding the inconsistent constraints at 110. The inconsistent constraints can include a single set of inconsistent constraints, which cannot be satisfied together, or a plurality of sets of inconsistent constraints such that the inconsistent constraints in a set are incapable of being satisfied together.

The inconsistent constraints can be found using a consistency checking technique. In the example provided herein, a known consistency checking technique referred to as arc-consistency is used to find the inconsistent constraints. Arc consistency eliminates values from each variable's value domain that can never participate in a valid solution. Each arc in a graph of a constraint network represents a binary constraint between two problem variables. The arc consistency algorithm iterates through each arc in the network graph and eliminates those values that do not satisfy the constraint between the two connected variables. This iteration continues until no more values can be eliminated in any arc. After the arc consistency algorithm stops, those arcs connecting variables with no values left in their domains are inconsistent.

Using the consistency checking technique, it is determined after iterating that there are two sets of inconsistent constraints, Set #1 which includes constraints C1, C2 and C5, and Set #2 which includes constraints C3, C4 and C6.

The method also includes generating tradeoffs for the inconsistent constraints at 112 which are capable of eliminating one or more of the inconsistent constraints. A binary constraint can be represented as the set of value pairs (vₐ,v_{b}) that satisfy the constraint cₓ between variables A and B. The tradeoff generation process takes each constraint in turn between variable A and B, and generates the value pairs that satisfy that constraint, ignoring any other constraints between A and B. Each new set of value pairs constitutes a potential tradeoff that the user can choose from. The step 110 of generating tradeoffs for the inconsistent constraints occurs during the optimization of the constraint satisfaction problem.

In this example, constraints C1, C2 and C5 cannot be satisfied together without providing some tradeoffs in the form of weightings. Constraints C1, C2, and C5 are given weightings which enable them to be satisfied by achieving a less than maximum score as described above. Similarly, constraints C3, C4 and C6 cannot be satisfied together without also providing some tradeoffs.

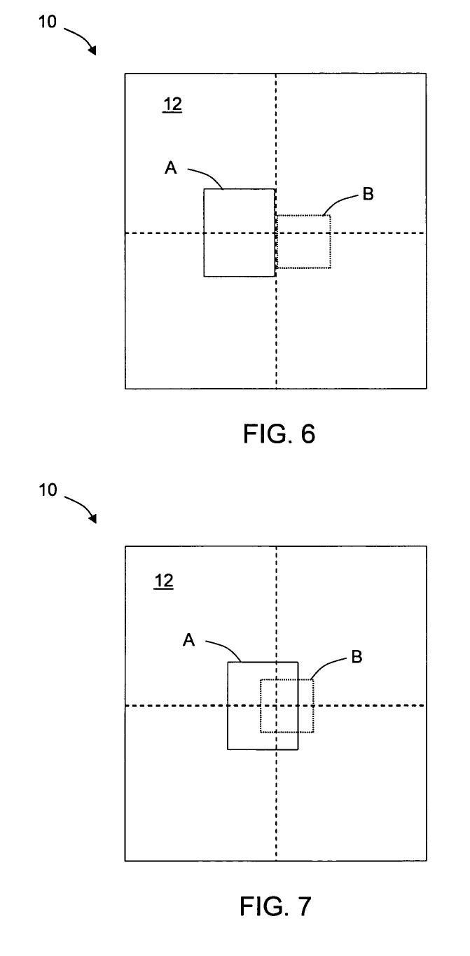

In the example provided, a number of solutions to the constraint satisfaction problem are generated identifying tradeoffs which eliminate the first set of inconsistencies, Set #1 (C1, C2, C5). Thus, a revised set of constraints, also referred to as tradeoff constraints, are generated for trading off horizontal balance of A and B for noOverlap. For example, one set of tradeoff constraints C1Rev and C2Rev, places A slightly left of origin and B slightly right of origin as shown by the layout in FIG. 6, which allows noOverlap to become perfect:
C1Rev: Aₓₚₒₛ<+0−A_{width}
C2Rev: Bₓₚₒₛ>=0

Another set of tradeoff constraints generated at 112 sacrifices noOverlap to achieve better HorizontalBalance, as shown by the layout in FIG. 7. In this instance, NoOverlap is relaxed to allow half of A to overlap with B as shown by:
C5Rev: Aₓₚₒₛ>=Bₓₚₒₛ=B_{width}
or Aₓₚₒₛ+A_{width}/2<+Bₓₚₒₛ

The method also includes the user interactively choosing acceptable tradeoffs at 114 from the tradeoff constraints (C1Rev, C2Rev, C5Rev) generated in step 112. Thus step 112 occurs during the optimization of the constraint satisfaction problem. For example, if the user selects the first set of tradeoff constraints (C1Rev, C2Rev) as an acceptable tradeoff, then these new constraints, also referred to as revised constraints, are added to the problem at 116 in place of the corresponding previous constraints (C1, C2), and problem solving continues by solving the constraint satisfaction problem using the revised constraints in step 104.

In this example, the tradeoff constraints selected at step 114 eliminate the remaining inconsistency (C3/C4/C6), since both A and B can be vertically centered on the page. Therefore, using the selected tradeoff constraints in the Constraint Satisfaction Problem optimization algorithm, in 104 optimizes all the constraints at 106 resulting in no remaining inconsistent constraints. Thus, the document layout is determined at 108, as shown by the solution in FIG. 7 such that the values chosen for the document parameters and document areas pass all of the specified constraints.

The present invention has many advantages, for instance, allowing the user to specify tradeoffs interactively during the optimization of the constraint satisfaction problem guides the system to convergence at an optimal solution while responding to dynamically changing preferences. It also alleviates the user to having to specify all preferences a priori thereby not requiring the document creator to have prior knowledge of the document content at the very beginning of the document creation process.

The present system and method also advantageously provides the ability to automate content selection, which is typically not part of the document layout process, i.e., content pieces are selected that satisfy the rest of the document constraints, thereby allowing automatic decisions to be made about which content to include in the document. This is in contrast to the typical approach of forcing the document creator to select all included content before layout is begun. The present invention also advantageously enables one to define constraints on other aspects of the document such as, for example, the constraint of whatever goes in this area should be Times-Roman font-type of size between 8 and 12 or line spacing constraints between differing types of text. Furthermore, the extension of the representation to a dynamic constraint satisfaction model enables more complicated documents to be represented and automatically created. It advantageously provides the capability to specify constraints on content items themselves such as, for example, the constraint that content should not be scaled more than 50% or that content cannot be on the same page as a certain advertisement.

While the invention is described with reference to a particular embodiment, this particular embodiment is intended to be illustrative, not limiting. Various modifications may be made without departing from the spirit and scope of the invention as defined in the amended claims. Modifications and alterations will occur to others upon reading and understanding this specification; therefore, it is intended that all such modifications and alterations are included insofar as they come within the scope of the appended claims or equivalents thereof.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. a method of determining a document layout of items in a: document comprising:
a. generating a constraint satisfaction problem describing the layout of the items in the document as a problem having constraints;
b. determining if the constraints are optimized;
c. finding inconsistent constraints which are incapable of being satisfied together;
d. generating tradeoffs for the inconsistent constraints capable of eliminating one or more of the inconsistent constraints;
e. a user choosing one or more of the tradeoffs as being one or more acceptable tradeoffs thereby forming revised constraints;
f. replacing constraints with revised constraints; and
g. repeating steps b-f until all constraints are optimized to no longer produce inconsistent constraints thereby determining a layout for the document.

2. The method defined in claim 1 wherein the step of finding inconsistent constraints comprises finding one set of inconsistent constraints which are incapable of being satisfied together.

3. The method defined in claim 1 wherein the step of finding inconsistent constraints comprises finding a plurality of sets of inconsistent constraints, wherein the inconsistent constraints in a set are incapable of being satisfied together.

4. The method defined in claim 3 wherein the step of generating tradeoffs further comprises generating a number of solutions to the optimization algorithm which identify tradeoffs to eliminate at least one of the plurality of sets of inconsistent constraints.

5. The method defined in claim 1 wherein the step of finding inconsistent constraints comprises using a consistency checking technique.

6. The method defined in claim 5 wherein the consistency checking technique comprises arc-consistency.

7. The method defined in claim 1 wherein the step of generating tradeoffs for the inconsistent constraints occurs during the optimization of the constraint satisfaction problem.

8. The method defined in claim 1 wherein the step of a user choosing one or more of the tradeoffs as being one or more acceptable tradeoffs occurs during the optimization of the constraint satisfaction problem.

9. A method of determining a document layout of items in a document comprising:
a. generating a constraint satisfaction problem describing the layout of the items in the document as a problem having constraints;
b. determining if the constraints are optimized;
c. finding inconsistent constraints which are incapable of being satisfied together;
d. generating tradeoffs during the optimization of the constraint satisfaction problem for the inconsistent constraints, the tradeoffs being capable of eliminating one or more of the inconsistent constraints;
e. a user choosing one or more of the tradeoffs as being one or more acceptable tradeoffs during the optimization of the constraint satisfaction problem thereby forming revised constraints;
f. replacing constraints with revised constraints; and
g. repeating steps b-f until all constraints are optimized to no longer produce inconsistent constraints thereby determining a layout for the document.

10. The method defined in claim 9 wherein the step of finding inconsistent constraints comprises finding one set of inconsistent constraints which are incapable of being satisfied together.

11. The method defined in claim 9 wherein the step of finding inconsistent constraints comprises finding a plurality of sets of inconsistent constraints, wherein the inconsistent constraints in a set are incapable of being satisfied together.

12. The method defined in claim 11 wherein the step of generating tradeoffs further comprises generating a number of solutions to the optimization algorithm which identify tradeoffs to eliminate at least one of the plurality of sets of inconsistent constraints.

13. The method defined in claim 9 wherein the step of finding inconsistent constraints comprises using a consistency checking technique.

14. The method defined in claim 13 wherein the consistency checking technique comprises arc-consistency.
